(19) United States
(12) Patent Application Publication
(10) Pub. No.: US 2025/0292305 A1
(43) Pub. Date: Sep. 18, 2025

(54) PRODUCT PURCHASE SUPPORT METHOD AND SYSTEM

(71) Applicant: SAMSUNG SDS CO., LTD., Seoul (KR)

(72) Inventors: Su Young KIM, Seoul (KR); Seung Hyun YOON, Seoul (KR)

(73) Assignee: SAMSUNG SDS CO., LTD., Seoul (KR)

(21) Appl. No.: 19/064,062

(22) Filed: Feb. 26, 2025

(30) Foreign Application Priority Data
Mar. 18, 2024 (KR) 10-2024-0036981
May 23, 2024 (KR) 10-2024-0067035

(51) Int. Cl. G06Q 30/0601; G06Q 30/0283

(52) U.S. Cl. CPC G06Q 30/0629; G06Q 30/0283; G06Q 30/0631

(57) ABSTRACT

There is provided a product purchase support method performed by a computing system. The method may include receiving, from a user terminal, first text expressed in natural language, extracting one or more product purchase-related items from the received first text, determining whether the first text contains sufficient product purchase-related information based on the one or more extracted items and transmitting, to the user terminal, a message requesting additional input when the first text is determined as not containing the sufficient product purchase-related information.

### CROSS-REFERENCE TO RELATED APPLICATIONS

This application claims priority from Korean Patent Application No. 10-2024-0036981 filed on Mar. 18, 2024 and Korean Patent Application No. 10-2024-0067035 filed on May 23, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a product purchase support method, and more specifically, to a product purchase support method and system that facilitate the purchase of products based on text expressed in natural language.

### 2. Description of the Related Art

Using cloud computing systems equipped with multiple processors, memories, storages, and the like, users can build virtual computing systems tailored to their work environments. For example, various cloud products leveraging the resources included in a cloud computing system may be prepared, allowing users to purchase specific cloud products to build the virtual computing systems they require.

However, purchasing suitable cloud products often requires users to input a significant amount of information. For example, users may need to enter multiple fields to select desired cloud products. Additionally, users may need to determine the sequence of calling multiple application programming interfaces (APIs) to purchase cloud products. Determining the API call sequence not only requires expert knowledge but may also result in the virtual computing systems associated with the cloud products failing to function properly if the API call sequence is incorrect.

### SUMMARY

An objective of the present disclosure is to provide a product purchase support method and system that enable convenient product purchase by recommending products based on text expressed in natural language.

Another objective of the present disclosure is to provide a product purchase support method and system that verify whether input text contains sufficient information relevant to purchasing a product.

Yet another objective of the present disclosure is to provide a product purchase support method and system that automatically determine an application programming interface (API) call sequence when purchasing a cloud product.

The objectives of the present disclosure are not limited to those mentioned above, and other objectives not explicitly stated will be clearly understood by those skilled in the art based on the following description.

According to an aspect of the present disclosure, there is provided a product purchase support method performed by a computing system, may comprise receiving, from a user terminal, first text expressed in natural language, extracting one or more product purchase-related items from the received first text, determining whether the first text contains sufficient product purchase-related information based on the one or more extracted items and transmitting, to the user terminal, a message requesting additional input when the first text is determined as not containing the sufficient product purchase-related information.

In some embodiments, the transmitting the message requesting additional input may comprise identifying missing items based on the one or more extracted items and transmitting the message requesting additional input for the missing items to the user terminal.

In some embodiments, the extracting the one or more product purchase-related items may comprise inputting the first text into a first artificial intelligence (AI) model and extracting the one or more product purchase-related items based on data output from the first AI model.

In some embodiments, the extracting the one or more product purchase-related items may comprise extracting a second item from the first text as a product purchase-related item when a similarity between a first item included in a required item list and the second item exceeds a threshold.

In some embodiments, the product purchase support method may further comprise generating a plurality of required item lists having different types by inputting a plurality of product data into a second AI model and wherein the second AI model is configured to generate the plurality of required item lists by clustering multiple items acquired from the plurality of product data.

In some embodiments, the determining whether the first text contains the sufficient product purchase-related information may comprise determining that the first text does not contain the sufficient product purchase-related information when a number of the one or more extracted items is less than or equal to a threshold.

In some embodiments, the product purchase support method may further comprise after the transmitting the message requesting additional input to the user terminal, receiving second text from the user terminal, generating one or more pieces of recommended product information by inputting the first text and the second text into a third AI model and transmitting the generated recommended product information to the user terminal.

In some embodiments, the recommended product information may include estimated cost information and product-related images.

In some embodiments, the product purchase support method may further comprise after the transmitting the recommended product information to the user terminal, receiving a purchase request for a recommended product corresponding to a specific piece of recommended product information, among the one or more pieces of recommended product information, from the user terminal, determining a sequence of calling a plurality of APIs for configuring the recommended product and creating a cloud product related to the recommended product based on the determined API call sequence.

In some embodiments, the determining the sequence of calling the plurality of APIs may comprise acquiring the sequence of calling the plurality of APIs by inputting information regarding the recommended product into the third AI model.

In some embodiments, the creating the cloud product related to the recommended product may comprise transmitting the determined API call sequence to the user terminal and calling each of the plurality of APIs based on the determined API call sequence in response to an API execution request being received from the user terminal.

In some embodiments, the product purchase support method may further comprise if it is determined that the first text contains the sufficient product purchase-related information, generating one or more pieces of recommended product information by inputting the first text into a third AI model and transmitting the generated recommended product information to the user terminal.

According to an aspect of the present disclosure, there is provided a product purchase support method performed by a computing system, may comprise receiving, from a user terminal, text expressed in natural language, acquiring one or more pieces of recommended product information, including estimated cost information and product-related images, by inputting the received text into an artificial intelligence (AI) model and transmitting the acquired recommended product information to the user terminal.

In some embodiments, the product purchase support method may further comprise after the transmitting the acquired recommended product information to the user terminal, receiving a purchase request for a recommended product corresponding to a specific piece of recommended product information, among the one or more pieces of recommended product information, from the user terminal, determining a sequence of calling a plurality of APIs for configuring the recommended product and creating a cloud product related to the recommended product based on the determined API call sequence.

In some embodiments, the creating the cloud product related to the recommended product may comprise transmitting the determined API call sequence to the user terminal and calling each of the plurality of APIs based on the determined API call sequence in response to an API execution request being received from the user terminal.

In some embodiments, the creating the cloud product related to the recommended product may comprise calling each of the plurality of APIs based on the determined API call sequence, monitoring execution results from the calling each of the plurality of APIs and generating error information related to a specific API that has resulted in execution failure, in response to the execution failure being detected in the specific API during the monitoring the execution results.

In some embodiments, the generating the error information may comprise acquiring program code modification data related to the specific API based on the error information, modifying a program related to the specific API based on the acquired program code modification data and recalling the specific API.

According to an aspect of the present disclosure, there is provided a computing system. The computing system may comprise at least one processor and a memory configured to load a computer program executed by the at least one processor, wherein the computer program may comprise instructions for operations of: receiving, from a user terminal, first text expressed in natural language, extracting one or more product purchase-related items from the received first text, determining whether the first text contains sufficient product purchase-related information based on the one or more extracted items; and transmitting, to the user terminal, a message requesting additional input when the first text is determined as not containing the sufficient product purchase-related information.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram illustrating a product purchase support system according to an embodiment of the present disclosure;

FIG. 2 is a diagram illustrating the acquisition of one or more items by entering input text into a first artificial intelligence (AI) model, according to an embodiment of the present disclosure;

FIG. 3 is a diagram illustrating the acquisition of a plurality of item lists by entering product data into a second AI model, according to an embodiment of the present disclosure;

FIG. 4 is a diagram illustrating a list of a plurality of items according to an embodiment of the present disclosure;

FIG. 5 is a diagram illustrating the acquisition of recommended product information by entering input text into a third AI model, according to an embodiment of the present disclosure;

FIG. 6 is a diagram illustrating the derivation of an application programming interface (API) call sequence is derived through a third AI model according to an embodiment of the present disclosure;

FIG. 7 is a diagram illustrating a neural network model according to an embodiment of the present disclosure;

FIG. 8 is a flowchart for explaining a product purchase support method according to an embodiment of the present disclosure;

FIG. 9 is a diagram illustrating the generation of a message requesting additional information when sufficient information is not included in first text for product purchase, according to an embodiment of the present disclosure;

FIG. 10 is a flowchart for explaining a method for creating a product selected by a user according to an embodiment of the present disclosure;

FIG. 11 is a diagram illustrating recommended product information according to an embodiment of the present disclosure;

FIG. 12 is a diagram illustrating an output screen on a user terminal when the creation of a cloud product is completed according to an embodiment of the present disclosure;

FIG. 13 is a flowchart for explaining a method for recalling an API in response to modification of program code related to an API in which an error has occurred, according to an embodiment of the present disclosure; and

FIG. 14 is a diagram illustrating the hardware configuration of a computing system according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Embodiments of the present disclosure will hereinafter be described in detail with reference to the accompanying drawings.

In embodiments of the present disclosure, the term “product” may refer to at least one of a cloud product, a financial product, a shopping product, and the like.

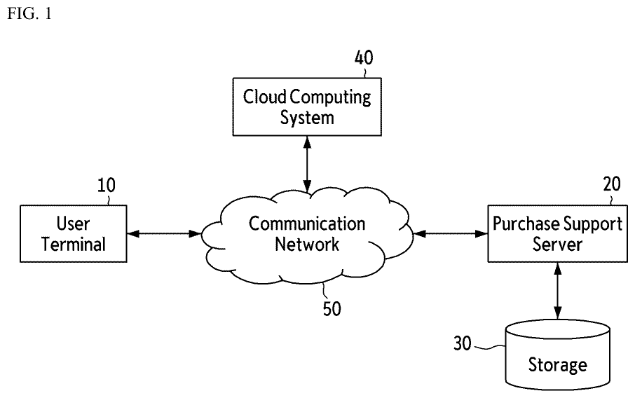

FIG. 1 is a diagram illustrating a product purchase support system according to an embodiment of the present disclosure. Referring to FIG. 1, the product purchase support system according to an embodiment of the present disclosure may include a user terminal 10, a purchase support server 20, a storage 30, and a cloud computing system 40. The user terminal 10, purchase support server 20, and cloud computing system 40 may communicate with each other via a communication network 50. Here, the communication network 50, which includes a mobile communication network and a wired communication network, is a well-known conventional technology, and thus, a detailed description thereof will be omitted.

The user terminal 10 may access the purchase support server 20 and transmit product purchase-related information to the purchase support server 20. In one embodiment, the user terminal 10 may transmit input text expressed in natural language to the purchase support server 20. The input text may include product purchase-related information. For example, the input text may contain one or more of product purchase-related sentences, phrases, or words. In some embodiments, the user terminal 10 may transmit product purchase-related text to the purchase support server 20 via a product purchase-related user interface.

Meanwhile, if the input text includes insufficient purchase-related information, the user terminal 10 may receive a message from the purchase support server 20 requesting additional information. Here, the purchase-related information may include words, phrases, sentences, and the like associated with one or more items that can identify products on sale, and the items may be understood as detailed information that can identify one or more specific products among a plurality of products. Including more items in the input text may narrow the range of products matched (or recommended) to the user may become.

In some embodiments, the user terminal 10 may receive a query message as the message requesting additional information. In this case, the user terminal 10 may receive a response to the query message from the user and transmit the received response to the purchase support server 20. The user terminal 10 may include a mobile communication device, a personal computer, a tablet computer, a laptop, or the like.

The cloud computing system 40 may be a system that includes a large amount of computing resources. Specifically, the cloud computing system 40 may include multiple processors, memories, storages, and the like. The cloud computing system 40 may also build a cloud product-related virtual computing system by using some of its computing resources.

The storage 30, as means for storing a large amount of data, may store a plurality of product-related data. Additionally, the storage 30 may store training datasets for training at least one artificial intelligence (AI) model, which will be described later. Furthermore, the storage 30 may store program code for executing programs related to application programming interfaces (APIs). The storage 30 may also store one or more databases for purchase support. In one embodiment, the storage 30 may store various databases such as a subscriber database and a cloud product database. The subscriber database may store subscriber information, including IDs, email addresses, mobile phone numbers, names, dates of birth, and the like. The cloud product database may store data related to a cloud product in use. The data related to a cloud product may include the numbers of users, type of usage, the status of allocated cloud computing resources, usage fee information, and the like.

The purchase support server 20 may generate one or more pieces of recommended product information based on the input text received from the user terminal 10 and transmit the generated information to the user terminal 10. In one embodiment, the purchase support server 20 may extract one or more product purchase-related items from the input text received from the user terminal 10 and determine whether the input text contains sufficient product purchase-related information based on the extracted items. If the number of items extracted from the input text is less than a threshold, the purchase support server 20 may determine that the input text does not contain sufficient product purchase-related information. For example, the purchase support server 20 may store an item list containing a plurality of required items and compare one or more items extracted from the input text with the item list to calculate the number of items extracted from the input text.

If the number of items extracted from the input text exceeds the threshold, the purchase support server 20 may determine that the input text contains sufficient product purchase-related information and proceed with a subsequent routine for product recommendation without requesting additional input from the user.

Conversely, if the number of items extracted from the input text is less than or equal to the threshold, the purchase support server 20 may determine that the input text contains insufficient product purchase-related information and send a message requesting additional input to the user terminal 10. At this time, the purchase support server 20 may send a query message to the user terminal 10 requesting input for any missing items.

In one embodiment, the purchase support server 20 may acquire the recommended product information by applying the input text to an AI model. Additionally, the purchase support server 20 may transmit the recommended product information to the user terminal 10.

The purchase support server 20 may proceed with a routine for product purchase processing based on product selection information received from the user terminal 10. For example, if the product to be purchased is a financial product, the purchase support server 20 may perform a subsequent routine related to drafting a contract, writing terms and conditions, transmitting a contract-completed document, processing a payment, and the like. As another example, if the product to be purchased is a shopping-related product, the purchase support server 20 may perform a subsequent relevant routine related to parcel dispatch, inputting a shipping address, processing a payment, and the like.

As yet another example, if the product to be purchased is a cloud product, the purchase support server 20 may perform a routine for building a virtual computing system. In this example, the purchase support server 20 may identify a plurality of APIs for configuring the selected cloud product and determine the sequence of calling the identified APIs. Additionally, the purchase support server 20 may determine a system architecture related to the number of virtual private clouds (VPCs), the number of virtual servers, subnet types, load balancer application status, and the like.

In one embodiment, the purchase support server 20 may enter the input text to a first AI model and determine whether the input text contains sufficient product purchase-related information based on data output by the first AI model. Also, the purchase support server 20 may enter the input text to a third AI model and acquire the recommended product information based on data output by the third AI model.

The following embodiments assume that the product to be purchased is a cloud product. However, it is clearly noted that the present disclosure is not limited thereto and may be utilized to support the purchase of various products.

A plurality of AI models for use in embodiments of the present disclosure will hereinafter be described. Each AI model may include an artificial neural network and may be pretrained.

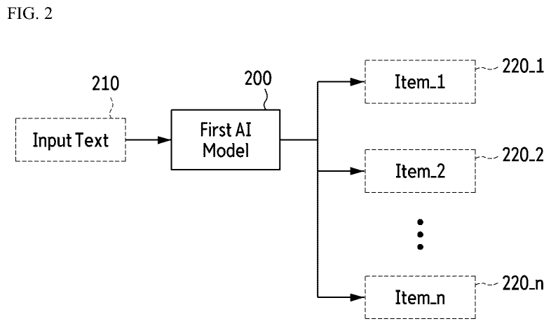

FIG. 2 is a diagram illustrating the acquisition of one or more items by entering input text into a first AI model, according to an embodiment of the present disclosure.

Referring to FIG. 2, the input text may be entered into the first AI model 200. Here, the input text 210 may be expressed in natural language, written by the user, and include product purchase-related information.

The first AI model 200 may extract one or more items 2201, 220_2, and 220_n from the input text 210. The number of items output from the first AI model 200 may be determined based on the information included in the input text 210. The first AI model 200 may be trained through supervised or semi-supervised learning to extract one or more items 2201, 220_2, and 220_n from text expressed in natural language. For example, the first AI model 200 may be trained using a training dataset including training input data and reference item data used as a correct answer.

The first AI model 200 may include a language model capable of processing natural language. For example, the first AI model 200 may include a natural language processing model such as Bidirectional Encoder Representations from Transformers (BERT) or Generative Pretrained Transformer (GPT).

In some embodiments, the items 220_1, 220_2, and 220_n output from the first AI model 200 may include features. Here, the features may be represented as multidimensional vectors.

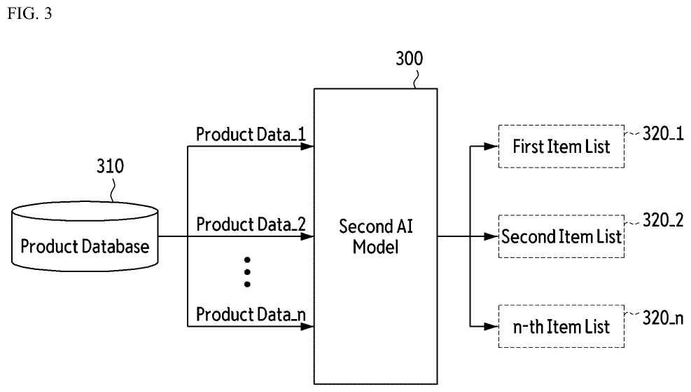

FIG. 3 is a diagram illustrating the acquisition of a plurality of item lists by entering product data into a second AI model, according to an embodiment of the present disclosure.

Referring to FIG. 3, a plurality of product data may be extracted from a product database 310 and entered into a second AI model 300. Here, the product data may include data related to a cloud product in actual use, such as the types of business and industry where the cloud product is used, type of system, usage location information, cost information, the number of users, the number of virtual servers, number of virtual private clouds (VPCs), API call sequence, subnet configuration value data, load balancer application status information, and the like.

The second AI model 300 may extract a plurality of required items from the plurality of product data and cluster the required items based on their similarities. Here, the second AI model 300 may be configured to cluster the required items using a clustering algorithm such as K-Means, Mean Shift, Gaussian Mixture Model (GMM), or Density-Based Spatial Clustering of Applications with Noise (DBSCAN).

FIG. 3 illustrates a plurality of item lists 320_1, 320_2, and 320_n as being generated based on the clustered required items. Specifically, the second AI model 300 may cluster required items with similar characteristics, extracted from the plurality of product data, thereby generating a plurality of item lists. For example, among the required items extracted from the plurality of product data, ‘B2C’ and ‘B2B’ may be included in a first item list (320_1) (e.g., a business type list), and ‘Seoul,’ ‘Daejeon,’ ‘Daegu,’ ‘Busan,’ and ‘Gwangju’ may be included in a second item list (320_2) (e.g., a usage location list). For example, among the required items extracted from the plurality of product data, ‘manufacturing and parts,’ ‘finance,’ and ‘distribution’ may be included in a third item list (e.g., an industry type list).

In some embodiments, the required items included in each of the item lists 320_1, 320_2, and 320_n may include text-associated features such as words, phrases, or expressions. For example, the required items may be represented as multidimensional vectors. In one embodiment, the second AI model 300 may be trained through supervised, semi-supervised, or unsupervised learning based on a plurality of product data for training.

The required items included in each of the item lists 3201, 320_2, and 320_n may include features that can be represented as multidimensional vectors. A determination may be made as to whether the input text contains items necessary for product purchase based on the similarity between the features of the required items output from the second AI model 300 and the features of the items output from the first AI model 200.

Meanwhile, a plurality of item lists may be manually created by an administrator and stored in the purchase support server 20. In this case, the second AI model 300 may not be utilized.

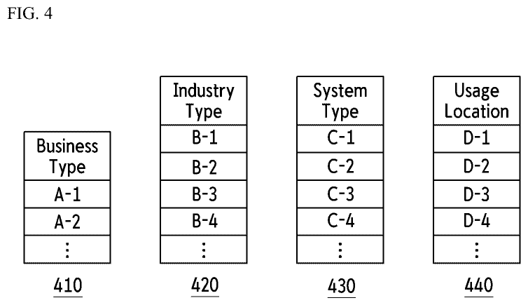

FIG. 4 is a diagram illustrating a plurality of item lists according to an embodiment of the present disclosure.

Referring to FIG. 4, a plurality of item lists 410, 420, 430, and 440 may be acquired using the second AI model 300. Each of the item lists 410, 420, 430, and 440 may include items with similar characteristics. For example, the first item list 410 may include a plurality of business type-related items A-1, A-2, . . . , and the second item list 420 may include a plurality of industry type-related items B-1, B-2, B-3, B-4, . . . . For example, the third item list 430 may include a plurality of system type-related items C-1, C-2, C-3, C-4, . . . , and the fourth item list 440 may include a plurality of usage location-related items D-1, D-2, D-3, D-4, . . . .

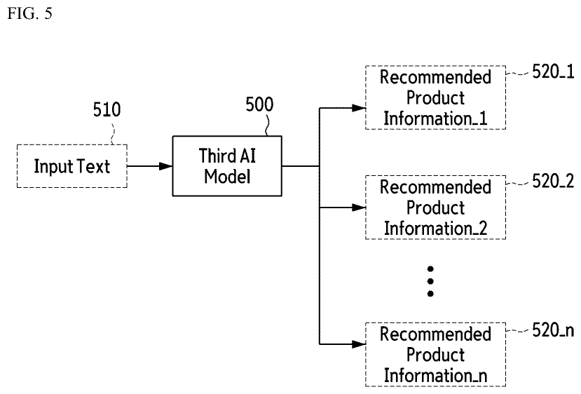

FIG. 5 is a diagram illustrating the acquisition of recommended product information by entering input text into a third AI model, according to an embodiment of the present disclosure.

Referring to FIG. 5, input text 510 in natural language may be entered into a third AI model 500, and the third AI model 500 may output one or more pieces of recommended product information 520_1, 520_2, and 520_n based on the input text 510 by analyzing the input text 510. The recommended product information 520_1, 520_2, and 520_n may each include at least one of cost information, product name information, or a product-related image. For example, if the product to be purchased is a cloud product, the product-related image may be a system diagram-related image.

The third AI model 500 may be a generative AI model trained to output the recommended product information 520_1, 520_2, and 520_n based on the input text 510. For example, the third AI model 500 may include a GPT model. The third AI model 500 may be a model trained based on a training dataset containing text expressed in natural language and reference candidate information used as a correct answer.

Additionally, the third AI model 500 may receive recommended product information selected by the user and output an API call sequence for configuring a cloud product related to the selected recommended product information.

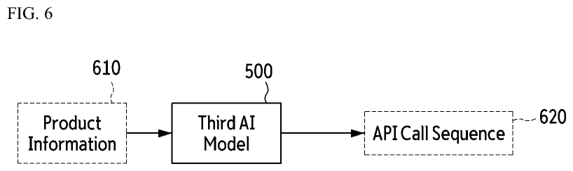

FIG. 6 is a diagram illustrating the derivation of an application programming interface (API) call sequence is derived through a third AI model according to an embodiment of the present disclosure.

Referring to FIG. 6, recommended product information may be entered into the third AI model 500, and the third AI model 500 may identify a plurality of APIs for configuring a virtual computing system and infer a call sequence 620 for the identified APIs based on the recommended product information. Here, the recommended product information may include product names and/or product images.

By calling APIs based on the inferred API call sequence 620 from the third AI model 500, computing resources may be allocated for creating a cloud product. In one embodiment, the third AI model 500 may be trained based on a training dataset that includes training product information and a reference API call sequence used as a correct answer. In some embodiments, the third AI model 500 may be configured to acquire the call sequence for a plurality of product identifier (e.g., product name)-related APIs from the product database included in the storage 30 and output the acquired API sequence.

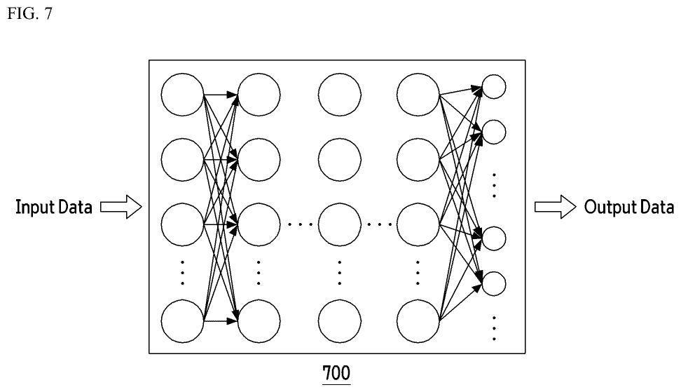

FIG. 7 is a diagram illustrating an artificial neural network model according to an embodiment of the present disclosure. The artificial neural network model 700, as an exemplary machine learning model, may be a statistical learning algorithm or a structure that executes the statistical learning algorithm, implemented based on the structure of a biological neural network in machine learning and cognitive science. In some embodiments, the artificial neural network model 700 may be included in at least one of the aforementioned first AI model, second AI model, or third AI model. That is, at least one of the first AI model, second AI model, or third AI model may be implemented as the artificial neural network model 700.

In one embodiment, the artificial neural network model 700, as in a biological neural network, may represent a machine learning model capable of problem-solving by repeatedly adjusting synaptic weights of artificial neurons, or nodes, which form a network through synaptic connections, to minimize the error between the correct output corresponding to a specific input and the inferred output. For example, the artificial neural network model 700 may include a probabilistic model or a neural network model used in machine learning or deep learning.

The artificial neural network model 700 may be implemented as a multilayer perceptron (MLP) consisting of multiple layers of nodes and their connections. The artificial neural network model 700 may be implemented using one of various artificial neural network structures that include an MLP. The artificial neural network model 700 may include an input layer for receiving input signals or data from an external source, an output layer for outputting signals or data corresponding to the input data, and n hidden layers (where n is a positive integer) located between the input and output layers, for receiving signals from the input layer, extracting features from the received signals, and transmitting the extracted features to the output layer.

In the artificial neural network model 700, a plurality of input variables and a plurality of output variables respectively corresponding to the plurality of input variables may be matched at the input and output layers, respectively. By adjusting the synaptic weights between nodes included in the input, hidden, and output layers, the artificial neural network model 700 can be trained to extract a correct output corresponding to a specific input. When the artificial neural network model 700 is iteratively trained based on data included in a training dataset, the synaptic weights (or weights) between the nodes are adjusted to reduce the error between output variables calculated from the input variables and target outputs, eventually converging to optimal values.

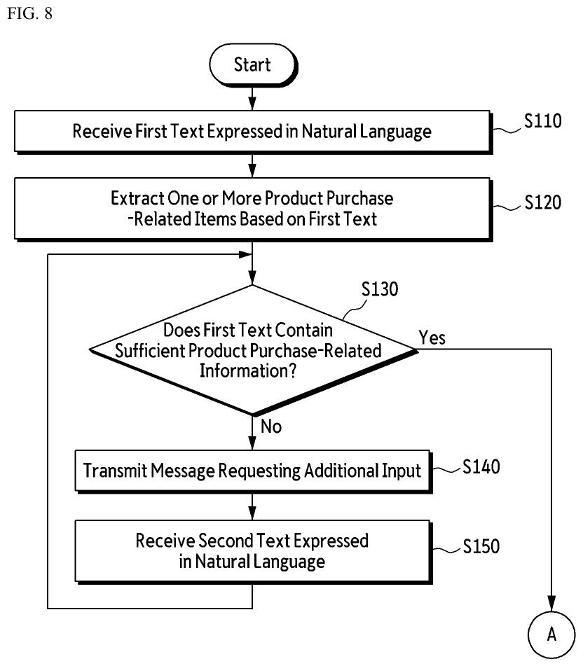

FIG. 8 is a flowchart illustrating a product purchase support method according to an embodiment of the present disclosure. The product purchase support method illustrated in FIG. 8 is merely exemplary for achieving the objectives of the present disclosure, and additional steps may be included, or some steps may be omitted as needed. Moreover, the product purchase support method illustrated in FIG. 8 may be performed by at least one processor included in a computing system. For ease of explanation, steps depicted in FIG. 8 will hereinafter be described as being performed by the purchase support server 20 in FIG. 1.

Referring to FIG. 8, a purchase support server may receive first text, expressed in natural language, from a user terminal (S110).

Subsequently, the purchase support server may extract one or more product purchase-related items from the first text (S120). In one embodiment, the purchase support server may input the first text into a first AI model and extract one or more product purchase-related items based on data output from the first AI model.

If the similarity between a first item included in a list of required items and a second item extracted from the first text exceeds a threshold, the purchase support server may extract the second item from the first text as a product purchase-related item. At this time, the similarity between the first and second items may be calculated based on the distance between a feature associated with the first item and a feature associated with the second item. This similarity may be calculated between each item included in a plurality of required item lists and each item extracted from the first text. As described above, a plurality of product data may be input into a second AI model, and a plurality of required item lists with different types may be generated. Here, the second AI model may be configured to generate a plurality of required item lists by clustering multiple items obtained from the product data.

Thereafter, based on the extracted product purchase-related items, the purchase support server may determine whether the first text contains sufficient product purchase-related information (S130).

In one embodiment, if the number of extracted product purchase-related items is less than or equal to a threshold, the purchase support server may determine that the first text does not contain sufficient product purchase-related information. Here, the number of extracted product purchase-related items may refer to the number of product purchase-related items belonging to different types. For example, if two product purchase-related items are extracted from the first text and are both associated with the same required item list (e.g., a location item list), the purchase support server may determine that the number of extracted product purchase-related items is one. As another example, if two product purchase-related items are extracted from the first text, with one associated with a first required item list (e.g., the location item list) and the other with a second required item list (e.g., an industry type item list), the purchase support server may determine that the number of extracted product purchase-related items is two.

If it is determined that the first text does not contain sufficient product purchase-related information, the purchase support server may send a message to the user terminal requesting additional input (S140). In one embodiment, the purchase support server may identify any missing items based on the extracted product purchase-related items and send a message to the user terminal requesting additional input for the missing items. The message may be a query message related to the missing items. For example, if the first text contains first, second, and third items, and the first item exceeds a threshold similarity with a fourth item in the first required item list, the second item exceeds the threshold similarity with a fifth item in the second required item list, and the third item exceeds the threshold similarity with a sixth item in a third required item list, the purchase support server may send a query message requesting additional information related to a fourth required item list. In other words, the purchase support server may determine that information related to the fourth required item list is missing in the first text and send a query message requesting additional input for the fourth required item list.

Thereafter, the purchase support server may receive second text containing additional information from the user terminal (S150). Thereafter, the purchase support server may proceed again with step S130 to determine whether the first text and the second text contain sufficient product purchase-related information.

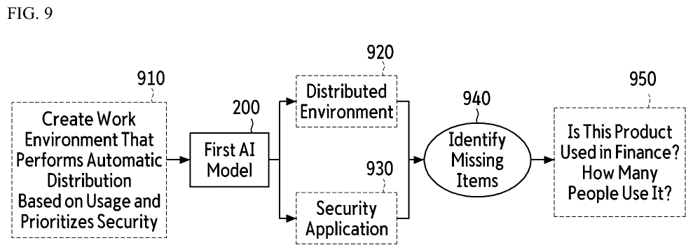

FIG. 9 is a diagram illustrating the generation of a message requesting additional information when the first text lacks sufficient product purchase-related information, according to an embodiment of the present disclosure.

Referring to FIG. 9, first text 910 may be received from a user terminal. Thereafter, the first text 910 may be input into a first AI model 200, thereby extracting a plurality of first and second items 920 and 930. FIG. 9 illustrates that the first item 920, which refers to a distributed environment, and the second item 930, which refers to security application, are extracted from the first text 910.

Thereafter, missing items in the first text 910 may be identified (940) based on a plurality of required item lists and the first and second items 920 and 930.

Thereafter, a message 950 requesting additional input for the missing items may be sent to the user terminal. FIG. 9 illustrates an example where a message querying usage information and the number of users as the missing items is sent to the user terminal.

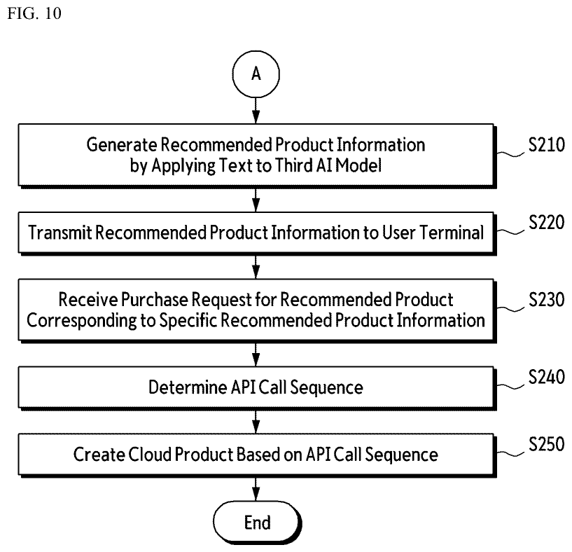

FIG. 10 is a flowchart illustrating a method for generating a product selected for purchase by a user, according to an embodiment of the present disclosure. The method depicted in FIG. 10 may be performed after the product purchase support method described in FIG. 8.

Referring to FIG. 10, the purchase support server may generate one or more pieces of recommended product information (S210) by inputting one or more pieces of text written by the user (i.e., the first text and/or the second text) into a third AI model. For example, if the first text and the second text are received from the user terminal, the purchase support server may input both the first text and the second text into the third AI model. If only the first text is received, the purchase support server may input only the first text into the third AI model.

Thereafter, the purchase support server may transmit the generated recommended product information to the user terminal (S220).

Thereafter, the purchase support server may receive a purchase request for a recommended product corresponding to a specific piece of recommended product information from among the one or more pieces of recommended product information from the user terminal (S230). Here, the recommended product information may include at least one of cost information, product name information, or a product-related image. For example, if the product to be purchased is a cloud product, the product-related image may include a system diagram-related image.

Thereafter, the purchase support server may determine the sequence of calling a plurality of APIs for configuring a specific recommended product requested to be purchased (S240). In one embodiment, the purchase support server may acquire the sequence of calling the plurality of APIs by inputting the information regarding the specific recommended product into the third AI model.

Thereafter, the purchase support server may create a cloud product associated with the specific recommended product based on the determined API call sequence. Specifically, the purchase support server may build a virtual computing system related to the cloud product by calling the plurality of APIs in the determined API call sequence. In one embodiment, the purchase support server may transmit the determined API call sequence to the user terminal, receive an API execution request from the user terminal, and call each of the plurality of APIs based on the determined API call sequence in response to the received API execution request. As the plurality of APIs are called, computing resources for building the virtual computing system may be allocated.

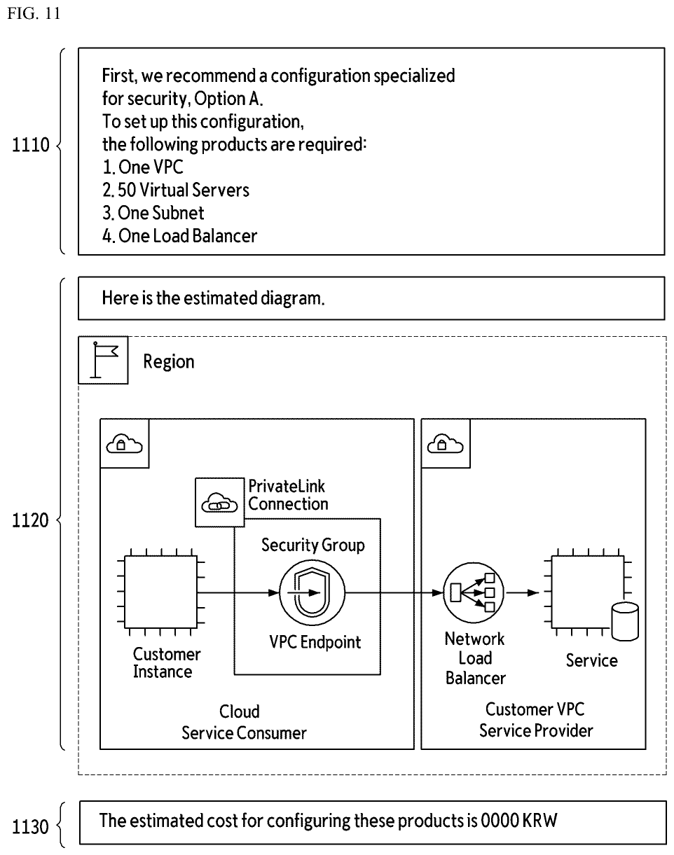

FIG. 11 is a diagram illustrating recommended product information according to an embodiment of the present disclosure.

Referring to FIG. 11, the recommended product information may include first information 1110 regarding the types and quantities of virtual resources allocated for configuring a cloud product, a system diagram 1120 for the cloud product, and estimated cost information 1130.

Meanwhile, if the user decides to purchase the specific recommended product, a plurality of APIs related to the specific recommended product may be called, and a virtual computing system associated with the corresponding cloud product may be built within a cloud computing system. While the cloud product is being built, related information may be transmitted to the user terminal.

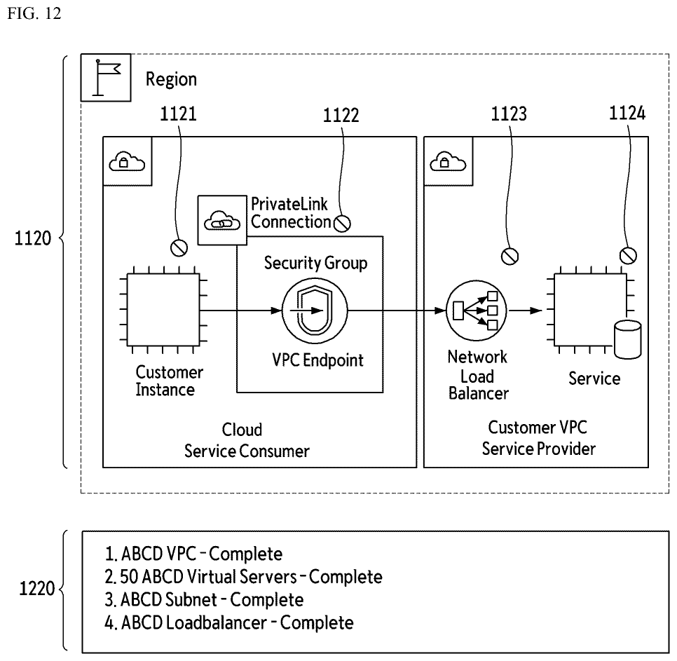

FIG. 12 is a diagram illustrating a screen output on the user terminal when the creation of a cloud product is completed, according to an embodiment of the present disclosure.

Referring to FIG. 12, when the cloud product has been successfully built and purchased, information regarding the completion status of virtual resources for building the cloud product and information regarding the build status of the cloud product may be visualized and output on a system diagram 1120. In FIG. 12, cycles are used as visualization elements 1121, 1122, 1123, and 1124 indicating the successful build of virtual devices. Although the visualization elements 1121, 1122, 1123, and 1124 are depicted in FIG. 12 as cycles, other forms of visualization such as colors or shapes may also be used.

Meanwhile, error may occur during the construction of a cloud product. In this case, error-related information may be generated, and program code related to the API where the error has occurred may be modified.

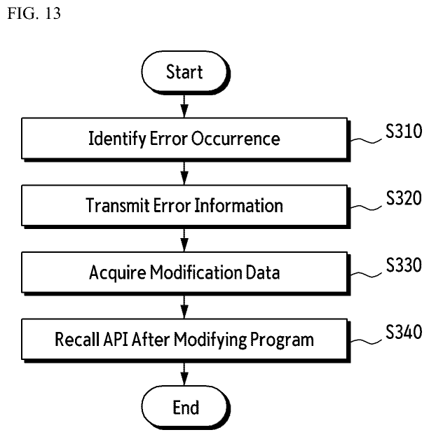

FIG. 13 is a flowchart illustrating a method for modifying program code related to an API where error has occurred and recalling the API, according to an embodiment of the present disclosure.

Referring to FIG. 13, a purchase support server may monitor execution results from the call of each of a plurality of APIs. For example, the purchase support server may monitor program execution results for each of the plurality of APIs by receiving the results of program execution related to API calls.

If the execution of an API-related program fails (i.e., execution failure or error occurs) during monitoring, the purchase support server may identify the API that has resulted in the execution failure (S310).

Thereafter, the purchase support server may generate error information related to the identified API and transmit the error information to the user terminal (S320).

Thereafter, the purchase support server may obtain modification data for revising a target program related to the identified API (S330). For example, the purchase support server may extract one or more modification data for revising the target program from a database where program code is stored. The database may contain multiple pieces of program code related to a single API, and the purchase support server may extract one or more pieces of program code related to the identified API as modification data. Alternatively, the purchase support server may request the administrator (e.g., a professional programmer) or the user to modify the program code related to the identified API and receive the modified program code as modification data.

Thereafter, the purchase support server may transmit the modification data to the user terminal as recommended data for modifying the failed program and receive selection information for specific modification data from the user terminal.

Thereafter, the purchase support server may revise the program code of the failed program based on the modification data selected by the user terminal and recall the API that has resulted in the execution failure (S340). Accordingly, when this API is recalled, the corresponding program may be executed based on the modified program code.

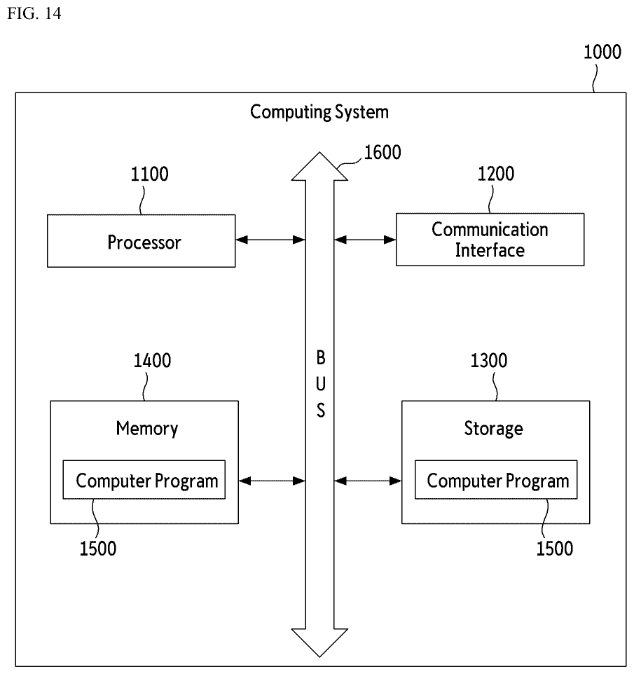

FIG. 14 is a hardware configuration view of an exemplary computing system 1000 according to some embodiments of the present disclosure. The computing system 1000 may include at least one processor 1100, a bus 1600, a communication interface 1200, a memory 1400, which loads a computer program 1500 to be executed by the processor 1100, and a storage 1300, which stores the computer program 1500.

The computing system 1000 of FIG. 14 may present a hardware structure of a computing system that constitutes the purchase support server 20 described with reference to FIG. 1.

The processor 1100 may control the overall operations of the components of the computing system 100. The processor 1100 may perform operations related to at least one application or program to execute operations/methods according to various embodiments of the present disclosure. The memory 1400 may store various data, commands, and/or information. The memory 1400 may load the computer program 1500 from the storage 1300 to execute the operations/methods according to various embodiments of the present disclosure. The storage 1300 may non-transitorily store at least one computer program 1500.

The computer program 1500 may include one or more instructions that enable the processor 1100 to perform the operations/methods according to various embodiments of the present disclosure when loaded into the memory 1400. In other words, by executing the loaded instructions, the processor 1100 may perform the operations/methods according to various embodiments of the present disclosure.

According to one embodiment, the computer program 1500 may include instructions for receiving, from a user terminal, first text expressed in natural language, extracting one or more product purchase-related items from the received first text, determining whether the first text contains sufficient product purchase-related information based on the extracted items and transmitting, to the user terminal, a message requesting additional input when the first text is determined as not containing sufficient product purchase-related information.

In some embodiments, the computing system 1000 as described with reference to FIG. 14 may be configured using one or more physical servers included in a server farm based on cloud technology such as virtual machines. In this case, at least some of the components as illustrated in FIG. 14, such as the processor 1100, the memory 1400, and the storage 1300 may be virtual hardware, and the communication interface 1200 may also be embodied as a virtualized networking element such as a virtual switch.

So far, a variety of embodiments of the present disclosure and the effects according to embodiments thereof have been mentioned with reference to FIGS. 1 to 14. The effects according to the technical idea of the present disclosure are not limited to the forementioned effects, and other unmentioned effects may be clearly understood by those skilled in the art from the description of the specification.

The methods according to the embodiments of the present disclosure described above may be performed by executing a computer program implemented using a computer-readable code. The computer program may be transmitted from a first computing device to a second computing device via a network such as the Internet and installed on the second computing device, and may be used by the second computing device. Furthermore, although the operations are illustrated in a specific order in the drawings, it should not be understood that the operations should be executed in the specific order as illustrated or in a sequential order or that all illustrated operations should be executed to acquire a desired result. In certain situations, multitasking and parallel processing may be advantageous.

Although some embodiments of the present disclosure have been described above with reference to the accompanying drawings, the present disclosure may not be limited to some embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that some embodiments as described above are not restrictive but illustrative in all respects.

What is claimed is:

1. A product purchase support method performed by a computing system, comprising:
receiving, from a user terminal, first text expressed in natural language;
extracting one or more product purchase-related items from the received first text;
determining whether the first text contains sufficient product purchase-related information based on the one or more extracted items; and
transmitting, to the user terminal, a message requesting additional input when the first text is determined as not containing the sufficient product purchase-related information.

2. The product purchase support method of claim 1, wherein the transmitting the message requesting additional input comprises: identifying missing items based on the one or more extracted items; and transmitting the message requesting additional input for the missing items to the user terminal.

3. The product purchase support method of claim 1, wherein the extracting the one or more product purchase-related items comprises: inputting the first text into a first artificial intelligence (AI) model; and extracting the one or more product purchase-related items based on data output from the first AI model.

4. The product purchase support method of claim 1, wherein the extracting the one or more product purchase-related items comprises extracting a second item from the first text as a product purchase-related item when a similarity between a first item included in a required item list and the second item exceeds a threshold.

5. The product purchase support method of claim 4, further comprising:
generating a plurality of required item lists having different types by inputting a plurality of product data into a second AI model; and
wherein the second AI model is configured to generate the plurality of required item lists by clustering multiple items acquired from the plurality of product data.

6. The product purchase support method of claim 1, wherein the determining whether the first text contains the sufficient product purchase-related information comprises determining that the first text does not contain the sufficient product purchase-related information when a number of the one or more extracted items is less than or equal to a threshold.

7. The product purchase support method of claim 1, further comprising:
after the transmitting the message requesting additional input to the user terminal, receiving second text from the user terminal;
generating one or more pieces of recommended product information by inputting the first text and the second text into a third AI model; and
transmitting the generated recommended product information to the user terminal.

8. The product purchase support method of claim 7, wherein the recommended product information includes estimated cost information and product-related images.

9. The product purchase support method of claim 7, further comprising:
after the transmitting the recommended product information to the user terminal, receiving a purchase request for a recommended product corresponding to a specific piece of recommended product information, among the one or more pieces of recommended product information, from the user terminal;
determining a sequence of calling a plurality of APIs for configuring the recommended product; and
creating a cloud product related to the recommended product based on the determined API call sequence.

10. The product purchase support method of claim 9, wherein the determining the sequence of calling the plurality of APIs comprises acquiring the sequence of calling the plurality of APIs by inputting information regarding the recommended product into the third AI model.

11. The product purchase support method of claim 9, wherein the creating the cloud product related to the recommended product comprises: transmitting the determined API call sequence to the user terminal; and calling each of the plurality of APIs based on the determined API call sequence in response to an API execution request being received from the user terminal.

12. The product purchase support method of claim 1, further comprising:
if it is determined that the first text contains the sufficient product purchase-related information, generating one or more pieces of recommended product information by inputting the first text into a third AI model; and transmitting the generated recommended product information to the user terminal.

13. A product purchase support method performed by a computing system, comprising:
receiving, from a user terminal, text expressed in natural language;
acquiring one or more pieces of recommended product information, including estimated cost information and product-related images, by inputting the received text into an artificial intelligence (AI) model; and
transmitting the acquired recommended product information to the user terminal.

14. The product purchase support method of claim 13, further comprising:
after the transmitting the acquired recommended product information to the user terminal, receiving a purchase request for a recommended product corresponding to a specific piece of recommended product information, among the one or more pieces of recommended product information, from the user terminal;
determining a sequence of calling a plurality of APIs for configuring the recommended product; and
creating a cloud product related to the recommended product based on the determined API call sequence.

15. The product purchase support method of claim 14, wherein the determining the sequence of calling the plurality of APIs comprises acquiring the sequence of calling the plurality of APIs by inputting information regarding the recommended product into the AI model.

16. The product purchase support method of claim 14, wherein the creating the cloud product related to the recommended product comprises: transmitting the determined API call sequence to the user terminal; and calling each of the plurality of APIs based on the determined API call sequence in response to an API execution request being received from the user terminal.

17. The product purchase support method of claim 14, wherein the creating the cloud product related to the recommended product comprises: calling each of the plurality of APIs based on the determined API call sequence; monitoring execution results from the calling each of the plurality of APIs; and generating error information related to a specific API that has resulted in execution failure, in response to the execution failure being detected in the specific API during the monitoring the execution results.

18. The product purchase support method of claim 17, wherein the generating the error information comprises: acquiring program code modification data related to the specific API based on the error information; modifying a program related to the specific API based on the acquired program code modification data; and recalling the specific API.

19. A computing system comprising:
at least one processor; and
a memory configured to load a computer program executed by the at least one processor,
wherein the computer program comprises instructions for operations of: receiving, from a user terminal, first text expressed in natural language; extracting one or more product purchase-related items from the received first text; determining whether the first text contains sufficient product purchase-related information based on the one or more extracted items; and transmitting, to the user terminal, a message requesting additional input when the first text is determined as not containing the sufficient product purchase-related information.
